(19) United States
(12) Patent Application Publication
(10) Pub. No.: US 2013/0293528 A1
(43) Pub. Date: Nov. 7, 2013

(54) DISPLAY DRIVING APPARATUS AND METHOD FOR DRIVING DISPLAY PANEL

(71) Applicant: NOVATEK MICROELECTRONICS CORP., Hsinchu (TW)

(72) Inventors: Chien-Yu Chen, Hsinchu County (TW); Yu-Hsun Peng, Hsinchu County (TW); Wei-Hsiu Chang, Taichung City (TW); Yu-Kuang Chang, Nantou County (TW)

(73) Assignee: Novatek Microelectronics Corp., Hsinchu (TW)

(21) Appl. No.: 13/888,372

(22) Filed: May 7, 2013

(30) Foreign Application Priority Data
May 7, 2012 (TW) 101116202

(51) Int. Cl. G09G 3/36

(52) U.S. Cl. CPC G09G 3/3696
USPC 345/212; 345/204; 345/87

(57) ABSTRACT

A display driving apparatus is disclosed. The display driving apparatus includes a display panel, a controller and a driving circuit. The controller receives a signal adjusting data and generates a driving controlling signal according to the signal adjusting data. The driving circuit separately provides a scanning driving signal and a data driving signal to a scanning line and a data line and adjusts at least one electrical property of the scanning driving signal and at least one electrical property of the data driving signal according to the driving controlling signal, wherein the signal adjusting data is generated according to an impedance value of the scanning line and the data line.

### CROSS-REFERENCE TO RELATED APPLICATION

This application claims the priority benefit of Taiwan application serial no. 101116202, filed on May 7, 2012. The entirety of the above-mentioned patent application is hereby incorporated by reference herein and made a part of this specification.

### BACKGROUND OF THE INVENTION

1. Field of the Invention

The invention relates to a display driving apparatus and a method for driving a display panel, and more particularly to a display driving apparatus and a method for driving a display panel, which are capable of adjusting driving waveforms.

2. Description of Related Art

The rapid progress of multimedia society benefits most from the advancing progress of semiconductor components or display apparatuses. As for displays, Thin Film Transistor Liquid Crystal Display (TFT-LCD) with superior characteristics of high picture quality, favorable space utilization efficiency, low power consumption and radiation-free has gradually become the mainstream in the market.

Since a display panel fabricated on a glass substrate mostly uses indium tin oxide (ITO) as a transparent conductive layer nowadays, the display panel in a process of surface layout generates different impedance values and causes a product of resistance and capacitance to vary greatly oftentimes because of inequality of length and/or width of scanning lines and data lines, or other factors. Such a situation as band mura and horizontal stripe image occurs in the display panel, thereby causing many problems of poor display quality. Display quality of the display panel is dramatically reduced. Such a matter also becomes an important issue.

### SUMMARY OF THE INVENTION

The invention provides a display driving apparatus and a method for driving a display panel to enhance display quality of the display panel.

The invention provides a display driving apparatus including a display panel, a controller and a driving circuit. The display panel includes a scanning line and a data line. The controller receives a signal adjusting data and generates a driving controlling signal according to the signal adjusting data. The driving circuit is coupled to the controller, the scanning line and the data line, and adjusts at least one electrical property of a scanning driving signal provided and at least one electrical property of a data driving signal provided according to the driving controlling signal. Moreover, the scanning driving signal is provided to the scanning line and the data driving signal is provided to the data line, wherein the signal adjusting data is generated according to impedance values of the scanning line and the data line.

The invention provides a method for driving a display panel, including: setting a signal adjusting data; generating a driving controlling signal according to the signal adjusting data; and adjusting at least one electrical property of a scanning driving signal provided and at least one electrical property of a data driving signal provided according to the driving controlling signal, wherein the signal adjusting data is generated according to impedance values of the scanning line and the data line.

Based on the above, the invention sets the signal adjusting data according to the impedance values of the scanning line and the data line and generates the driving controlling signal according to the signal adjusting data. In addition, at least one electrical property of the scanning driving signal provided and at least one electrical property of the data driving signal provided are adjusted according to the driving controlling signal. Accordingly, when the user carries out the surface layout of the display panel, a huge variation in a product of resistance and capacitance is improved. A situation of band mura and horizontal stripe image in the display panel, which results in many problems of poor display quality, is improved to enhance display quality of the display panel.

Embodiments are illustrated with reference to the accompanying drawings in detail below to make the aforementioned features and advantages of the invention more comprehensible.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic view illustrating a framework of a display driving apparatus according to an embodiment of the invention.

FIGS. 2A-2D are respectively schematic views illustrating adjusting waveforms of scanning driving signals SDS1-SDS4 according to an embodiment of the invention.

FIG. 3A is a schematic view of a display panel according to an embodiment of the invention.

FIG. 3B is a schematic view illustrating driving waveforms of adjusting gamma driving voltages according to an embodiment of the invention.

FIG. 3C is a schematic view illustrating driving waveforms of adjusting driving enabling times according to an embodiment of the invention.

FIG. 4 is a schematic view illustrating clustering of driving signals of a display driving apparatus according to an embodiment of the invention.

FIG. 5 is a schematic view illustrating clusters of driving waveforms of a sub-frame period according to an embodiment of the invention.

FIG. 6 is a flowchart of a method for driving a display panel according to an embodiment of the invention.

### DESCRIPTION OF EMBODIMENTS

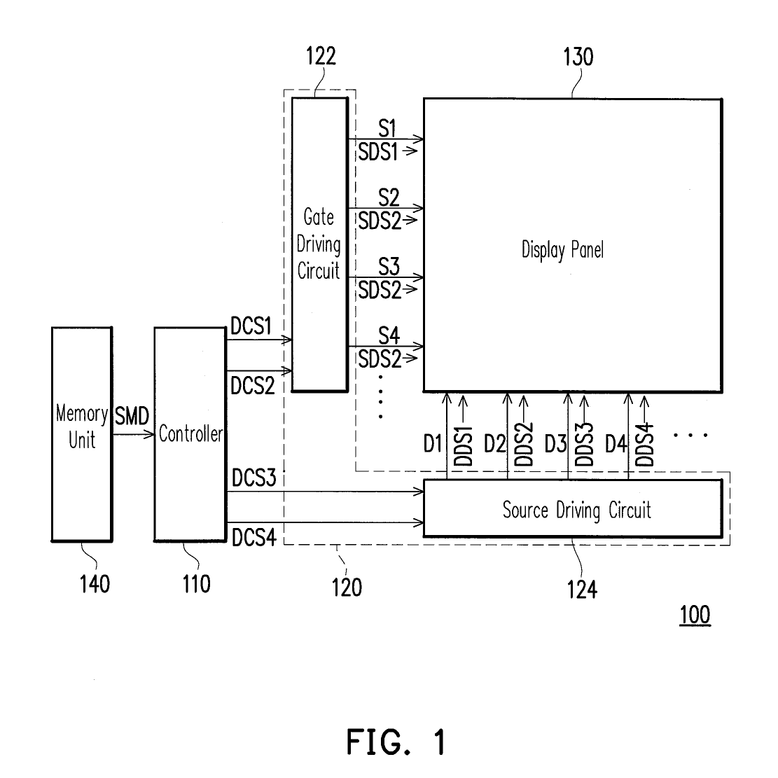

Referring to FIG. 1, FIG. 1 is a schematic view illustrating a framework of a display driving apparatus according to an embodiment of the invention. A display driving apparatus 100 includes a controller 110, a driving circuit 120, a display panel 130 and a memory unit 140. The display driving apparatus 100 is used to drive the display panel 130. The display panel 130 includes multiple scanning lines S1-S4 and multiple data lines D1-D4. The memory unit 140 is coupled to the controller 110, and is used to store a signal adjusting data SMD and provides the signal adjusting data SMD to the controller 110. The memory unit 140 is a One-Time Programming (OTP) non-volatile memory or other types of non-volatile memories. Alternatively, the memory unit 140 is also a register composed of digital logic gates, but not limited thereto.

The controller 110 receives the signal adjusting data SMD via the memory unit 140 and generates multiple driving controlling signals DCS1-DCS4 according to the signal adjusting data SMD. The driving circuit 120 is coupled to the controller 110, the scanning lines S1-S4 and the data lines D1-D4, and adjusts at least one electrical property of scanning driving signals SDS1-SDS4 provided and the data driving signals DDS1-DDS4 provided according to the driving controlling signals DCS1-DCS4.

Moreover, the driving circuit 120 provides the scanning driving signals SDS1-SDS4 to the scanning lines S1-S4 respectively and correspondingly to control ON or OFF state of a thin film transistor (TFT) of the display panel 130. Furthermore, the driving circuit 120 respectively and correspondingly provides the data driving signals DDS1-DDS4 to the data lines D1-D4 to write displaying data into pixels of the display panel 130. Herein, the signal adjusting data SMD is generated according to impedance values of the scanning lines S1-S4 and the data lines D1-D4.

Furthermore, the driving circuit 120 includes a gate driving circuit 122 and a source driving circuit 124. The gate driving circuit 122 is coupled to the controller 110 as well as the scanning lines S1-S4 and is used to adjust at least one electrical property of the scanning driving signals SDS1-SDS4 generated according to the driving controlling signals DCS1-DCS2. The source driving circuit 124 is coupled to the controller 110 as well as the data lines D1-D4 and is used to adjust at least one electrical property of the data driving signals DDS1-DDS4 generated according to the driving controlling signals DCS3-DCS4.

As exemplified by a transparent conductive layer made of indium tin oxide by a chip-on-glass (COG) technique on a glass substrate (not shown), the scanning lines S1-S4 and the data lines D1-D4 on the display panel 130 are constructed by indium tin oxide. Due to a positional relationship of the display panel 130, the gate driving circuit 122 and the source driving circuit 124, the scanning lines S1-S4 and the data lines D1-D4 have different line widths and lengths. As a result, a phenomenon of different impedance values possessed by different scanning lines S1-S4 and different data lines D1-D4 occurs.

In this embodiment, designers detect the impedance values of the scanning lines S1-S4 and the data lines D1-D4 on the display panel 130 to set the signal adjusting data SMD stored in the memory unit 140 correspondingly. Moreover, the gate driving circuit 122 is driven by the signal adjusting data SMD to generate the scanning driving signals SDS1-SDS4 with different electrical properties to be transmitted to the scanning lines S1-S4, and the source driving circuit 124 is driven to generate the data driving signals DDS1-DDS4 with different electrical properties to be transmitted to the data lines D1-D4. This embodiment adjusts at least one of the electrical properties of the scanning driving signals SDS1-SDS4, including driving enabling time, driving voltage and driving current, and adjusts at least one of gamma driving voltage and driving enabling time of the data driving signals DDS1-DDS4 to compensate for performance degradation resulting from uneven impedances on the scanning lines S1-S4 and the data lines D1-D4.

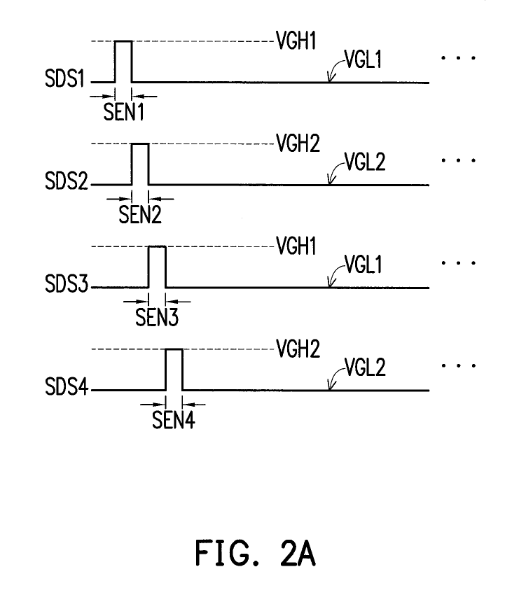

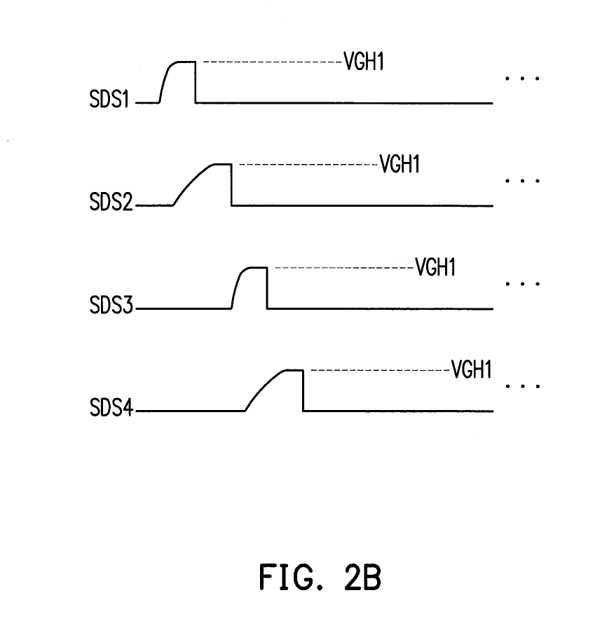

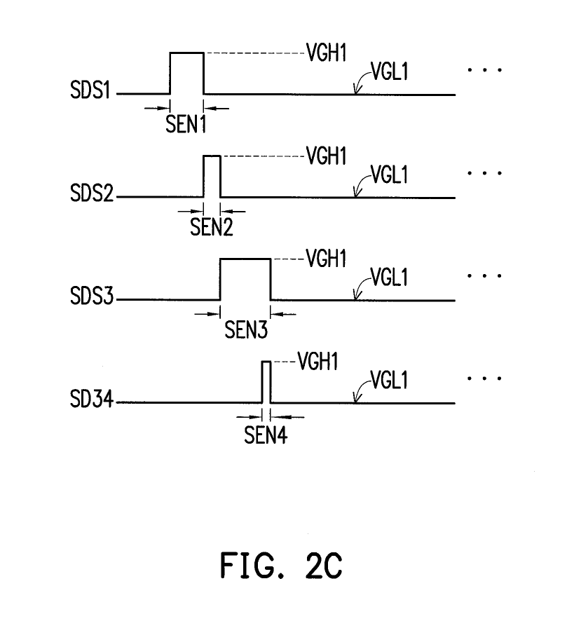

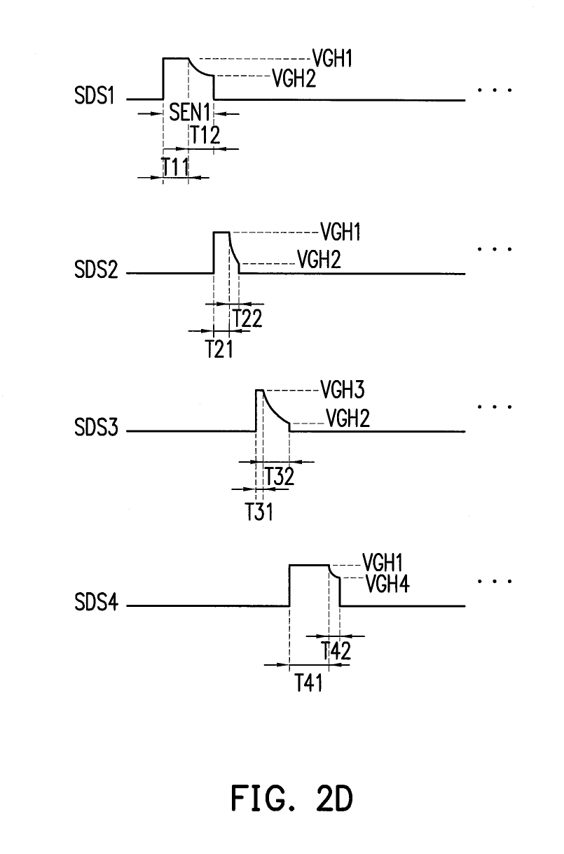

FIG. 1 and FIGS. 2A-2D are referred to in the following, wherein FIGS. 2A-2D are respectively schematic views illustrating adjusting waveforms of the scanning driving signals SDS1-SDS4 according to an embodiment of the invention. As shown in FIG. 2A, driving voltages of the scanning driving signals SDS1 and SDS3 respectively in a scanning enabling period SEN1 and a scanning enabling period SEN3 are equal to a scanning driving voltage VGH1 while driving voltages of the scanning driving signals SDS2 and SDS4 respectively in a scanning enabling period SEN2 and a scanning enabling period SEN4 are equal to a scanning driving voltage VGH2, wherein the scanning driving voltage VGH1 and the scanning driving voltage VGH2 are not the same (e.g. the scanning driving voltage VGH1 is higher than the scanning driving voltage VGH2). Besides, a driving voltage of the scanning driving signals SDS1 and SDS3 in a time interval other than their respective scanning enabling periods SEN1 and SEN3 is equal to a scanning driving voltage VGL1 while a driving voltage of the scanning driving signals SDS2 and SDS4 in a time interval other than their respective scanning enabling periods SEN2 and SEN4 is equal to a scanning driving voltage VGL2, wherein the scanning driving voltage VGL1 and the scanning driving voltage VGL2 are not the same (e.g. the scanning driving voltage VGL1 is lower than the scanning driving voltage VGL2).

Following the above example, the relatively high scanning driving voltage VGH1 is provided as the driving voltages of the scanning driving signals SDS1 and SDS3 respectively in the scanning enabling periods SEN1 and SEN3 when the impedance values of the scanning lines S1 and S3 within the scanning enabling periods SEN1 and SEN3 correspondingly received are larger than the impedance values of other scanning lines (the scanning lines S2 and S4). In contrast, the relatively low scanning driving voltage VGH2 is provided as the driving voltages of the scanning driving signals SDS2 and SDS4 respectively within the scanning enabling periods SEN2 and SEN4 in the light of relatively low impedance values of the scanning lines S2 and S4.

As shown in FIG. 2B, pull-ups of the scanning driving signals SDS1-SDS4 respectively in the scanning enabling periods SEN1-SEN4 to a current driving capacity of the scanning driving voltage VGH1 are not the same. As for this embodiment, the scanning driving signals SDS1-SDS4 require different time to be pulled up to the scanning driving voltage VGH1 respectively in the scanning enabling periods SEN1-SEN4, wherein the more quickly the scanning driving signals are pulled up to be equal to the scanning driving voltage VGH1, the higher the current driving capacity.

When the scanning lines to which the scanning driving signals correspond have higher impedance values (as exemplified by the scanning driving signal SDS1), this embodiment upgrades the current driving capacity provided from the gate driving circuit 122 to the scanning driving signal SDS1, so as to make the scanning driving signal SDS1 become equal to the scanning driving voltage VGH1 more quickly in the scanning enabling period SEN1 thereof. Of course, this embodiment makes the scanning driving signal SDS2 become equal to the scanning driving voltage VGH1 more slowly in the scanning enabling period SEN2 thereof by downgrading the current driving capacity provided from the gate driving circuit 122 to the scanning driving signal SDS2 when the scanning lines which the scanning driving signals correspond to have lower impedance values (as exemplified by the scanning driving signal SDS2). Accordingly, the feed-through phenomenon, which is caused by overly-fast conduction of the thin film transistor on pixels and results in display data being transmitted by the data lines to the wrong pixels, is prevented.

As shown in FIG. 2C, the driving voltage of the scanning driving signals SDS1-SDS4 respectively in the scanning enabling periods SEN1-SEN4 is equal to the scanning driving voltage VGH1 while the driving voltage of the scanning driving signals SDS1-SDS4 in a time interval other than their respective scanning enabling periods SEN1-SEN4 is equal to the scanning driving voltage VGL1. In this embodiment, widths of the scanning enabling periods SEN1-SEN4 of the scanning driving signals SDS1-SDS4 apiece are individually adjustable. As learned from FIG. 2C, time widths of the scanning enabling periods SEN1-SEN4 of the scanning driving signals SDS1-SDS4 are in a sequence of: the scanning enabling period SEN3>the scanning enabling period SEN1>the scanning enabling period SEN2>the scanning enabling period SEN4.

In other words, in this embodiment, the scanning driving signals transmitted by the scanning lines with larger impedance values are adjusted to have longer scanning enabling periods. Relatively, the scanning driving signals transmitted by the scanning lines with smaller impedance values are adjusted to have shorter scanning enabling periods. In this embodiment, the impedance values of the scanning driving signals SDS1-SDS4 are in a sequence of: the scanning driving signal SDS3>the scanning driving signal SDS1>the scanning driving signal SDS2>the scanning driving signal SDS4.

It should be noted that, in other embodiments, the above driving voltage, driving capacity and driving enabling time of the scanning driving signals SDS1-SDS4 are collocated with each other to further enhance display performance when it is difficult to achieve a predetermined display quality of the display panel 130 by merely adjusting one electrical property of the scanning driving signals SDS1-SDS4.

Moreover, the embodiments of the invention are applicable to the scanning driving signals SDS1-SDS4 generating chamfered driving waveforms. The chamfered driving waveforms are used primarily in prevention of feed-through resulting from overly-low speed of conducting and shutting of the thin film transistor. In this embodiment, scanning driving waveforms are chamfered in a rear section of the scanning enabling period (that is, close to falling edges of the scanning driving waveforms) to reduce effects of a feed-through voltage.

In this embodiment, the controller 110 makes each of the scanning driving signals SDS1-SDS4 generated by the driving circuit 120 include two scanning sub-periods in their respective scanning enabling periods SEN1-SEN4 via the driving controlling signals DCS1-DCS4. As exemplified by the scanning driving signal SDS1 in the scanning enabling period SEN1, the scanning enabling period SEN1 includes a scanning sub-period T11 and a scanning sub-period T12 wherein the scanning driving signal SDS1 is equal to the scanning driving voltage VGH1 when the scanning driving signal SDS1 is in the scanning sub-period T11 and the scanning driving signal SDS1 is pulled down to the scanning driving voltage VGH2 when the scanning driving signal SDS1 is in the scanning sub-period T12.

Of course, widths of the scanning sub-periods of the scanning driving signals SDS1-SDS4 apiece can be individually set, and the driving voltages in correspondence thereto can also be individually set. As exemplified by this embodiment and shown in FIG. 2D, lengths of the scanning sub-periods assigned to the scanning enabling periods of the scanning driving signals SDS1-SDS4 can respectively be individually set. As exemplified by the scanning driving signals SDS1 and SDS2, the length of the scanning sub-period T11 and the length of a scanning sub-period T21 are not the same while the length of the scanning sub-period T12 and the length of a scanning sub-period T22 are not the same. Besides, the scanning driving voltages to which the scanning driving signals SDS1, SDS2, SDS3 and SDS4 correspond in different scanning sub-periods are not the same. As exemplified by the scanning driving signals SDS3 and SDS4, the scanning driving signal SDS3 in a scanning sub-period T31 remains equal to a scanning driving voltage VGH3 while the scanning driving signal SDS3 in a scanning sub-period T32 is pulled down to be equal to the scanning driving voltage VGH2; and the scanning driving signal SDS4 in a scanning sub-period T41 remains equal to the scanning driving voltage VGH1 while the scanning driving signal SDS4 in a scanning sub-period T42 is pulled down to be equal to a scanning driving voltage VGH4, wherein the scanning driving voltage VGH1 and the scanning driving voltage VGH3 are unequal while the scanning driving voltage VGH2 and the scanning driving voltage VGH4 are unequal.

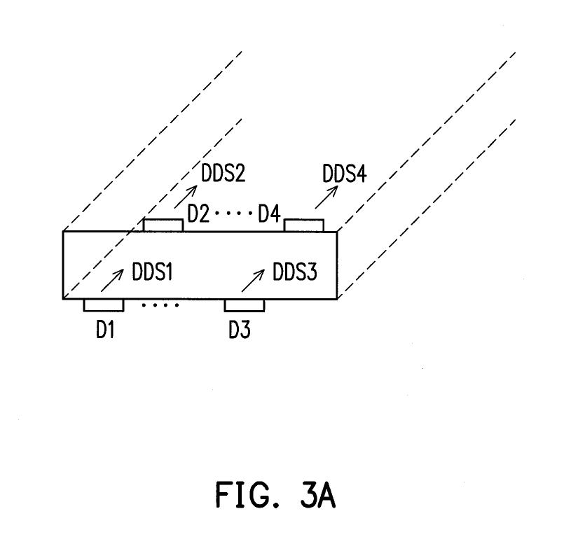

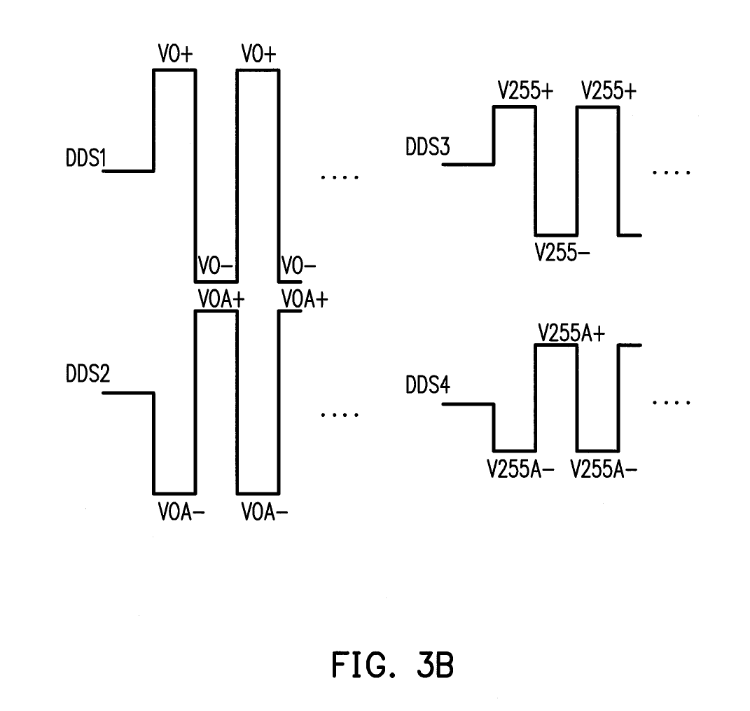

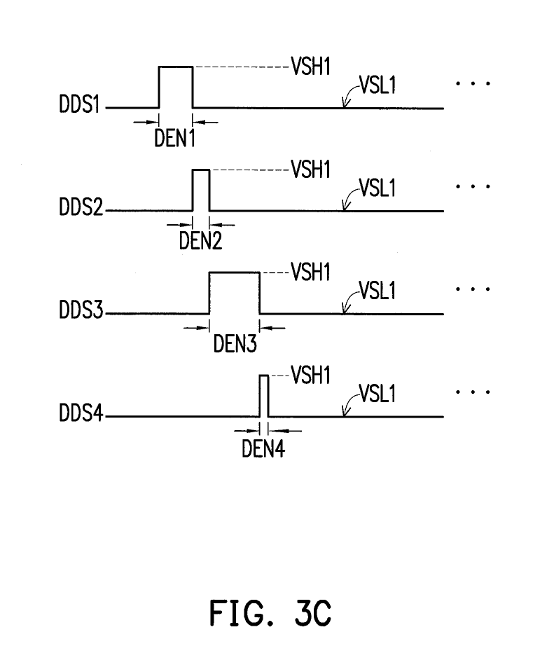

FIGS. 3A-3B are referred to simultaneously in the following. FIG. 3A is a schematic view of a display panel according to an embodiment of the invention. FIG. 3B is a schematic view illustrating driving waveforms of adjusting gamma driving voltage according to an embodiment of the invention. The display panel is laid out in an upper layer and a lower layer while the data lines D2 and D4 and the data lines D1 and D3 respectively correspond to the upper layer and the lower layer. In this embodiment, different gamma voltages are respectively set for the data lines D1-D4 of the upper layer and the lower layer to reduce effects of different impedance values generated by the data lines D1-D4, thereby achieving the predetermined display quality.

As shown by the adjusted waveforms in FIG. 3B, the source driving circuit outputs the data driving signals DDS1-DDS4 according to the driving controlling signals received after outputting the driving controlling signals into the source driving circuit via the signal adjusting data received by the controller. Designer can adjust electrical properties of the gamma driving voltages of the data driving signals DDS1-DDS4 in accordance with design requirements to achieve a predetermined display quality of the display panel. Moreover, Voltage V0+ of the data driving signal DDS1 and Voltage V0A+ of the data driving signal DDS2 are not the same while Voltage V255+ of the data driving signal DDS3 and Voltage V255A+ of the data driving signal DDS4 are not the same in this embodiment. However, this embodiment is not limited thereto.

FIG. 3C is a schematic view illustrating driving waveforms of adjusting driving enabling times according to an embodiment of the invention. Referring to FIG. 3C, the same as the embodiment of FIG. 2C wherein the scanning enabling periods of the scanning driving signals are adjusted, this embodiment adjusts data enabling periods DEN1-DEN4 according to the impedance values of the data lines DDS1-DDS4 apiece. A driving voltage of the data driving signals DDS1-DDS4 respectively in the data enabling periods DEN1˜DEN4 is a data driving voltage VSH1 while a driving voltage of the data driving signals DDS1-DDS4 in a time interval other than their respective scanning enabling periods DEN1-DEN4 is a data driving voltage VSL1. As can be learned from FIG. 3C, time widths of the data enabling periods DEN1-DEN4 of the data driving signals DDS1-DDS4 are in a sequence of: the data enabling period DEN3>the data enabling period DEN1>the data enabling period DEN2>the data enabling period DEN4.

In other words, in this embodiment, the data driving signals transmitted by the data lines with higher impedance values are adjusted to have longer data enabling periods. Relatively, the data driving signals transmitted by the data lines with lower impedance values are adjusted to have shorter data enabling periods in this embodiment. In this embodiment, the impedance values of the data driving signals DDS1-DDS4 are in a sequence of: the data driving signal DDS3>the data driving signal DDS1>the data driving signal DDS2>the data driving signal DDS4.

As can be learned from the above, referring to FIG. 1 again, the impedance values generated by the scanning lines S1-S4 or data lines D1-D4 may include a variety of values; nevertheless, adjusting at least one of the above-mentioned electrical properties of the scanning driving signals SDS1-SDS4 and at least one of the gamma driving voltage and the driving enabling time of the data driving signals DDS1-DDS4 is a way to respond. In other words, in this invention, various driving waveforms of the scanning driving signals SDS1-SDS4 and various driving waveforms of the data driving signals DDS1-DDS4 are adjusted according to the impedance values of the scanning lines S1-S4 or data lines D1-D4. Effects resulting from a huge variation in a product of resistance and capacitance are significantly reduced and feed-through effects are improved by proper planning of timing and transmission arrangements of the adjusted driving waveforms through the controller 110, and thus the display quality of the display panel 130 is enhanced.

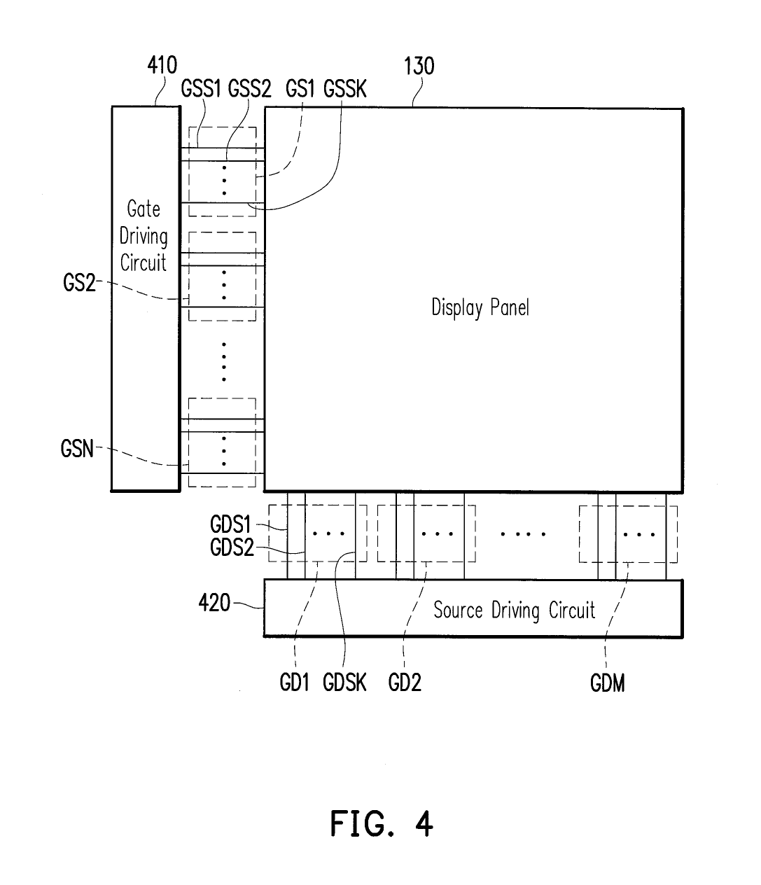

Referring to FIG. 4 next, FIG. 4 is a schematic view illustrating clustering of driving signals of a display driving apparatus according to an embodiment of the invention. In this embodiment, the controller divides the scanning lines into N scanning line clusters GS1-GSN and divides the data lines into M data line clusters GD1-GDM according to the impedance values of the scanning lines and the data lines that couple a gate driving circuit 410 and a source driving circuit 420 to the display panel 130, wherein N and M are positive integers.

Moreover, data recorded by the signal adjusting data includes N adjusting values of the scanning driving signals and M adjusting values of the data driving signals. Consequently, at least one electrical property of scanning driving signals GDS1-GDSk transmitted by the scanning line clusters GS1-GSN apiece is adjusted and at least one electrical property of data driving signals GSS1-GSSk transmitted by the data line clusters GD1-GDM apiece is adjusted. Herein, adjustment methods for the data driving signals classified as belonging to the same cluster are the same while adjustment methods for the scanning driving signals classified as belonging to the same cluster are the same.

It should be noted that the numbers of the scanning lines in the scanning line clusters GS1-GSN are not necessarily the same while the numbers of the data lines in the data line clusters GD1-GDM are not necessarily the same. The number of the scanning lines possessed by the scanning line clusters GS1-GSN apiece and the number of the data lines possessed by the data line clusters GD1-GDM apiece individually are equal to at least 1.

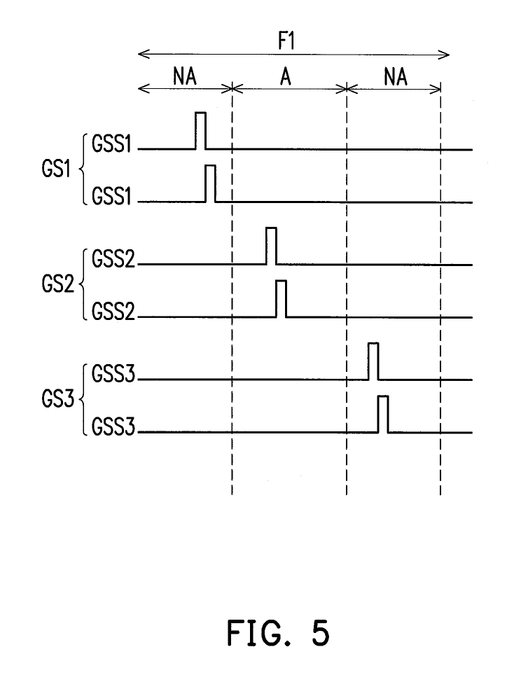

Referring to FIG. 5, FIG. 5 is a schematic view illustrating clusters of driving waveforms of a sub-frame period according to an embodiment of the invention. As shown in FIG. 5, the controller distinguishes the clusters of the scanning lines from the clusters of the data lines based on a display screen of the display panel in this embodiment. As exemplified by a sub-frame period F1 of a frame period, the controller divides the sub-frame period F1 into a display part cycle A and a non-display part NA. The scanning line clusters GS1-GS3 transmit the scanning driving signals GSS1-GSS3 according to the set electrical properties to control On and Off state of a thin film transistor, so as to write display data hereby into pixels of the display panel to present partial display effects of display screen. Moreover, the controller adjusts at least one of driving voltage, driving capacity and driving enabling time of the scanning driving signals GSS1-GSS3 according to the adjusting values of the scanning driving signals since the signal adjusting data received by the controller includes the adjusting values of the scanning driving signals. Better display quality is hereby achieved.

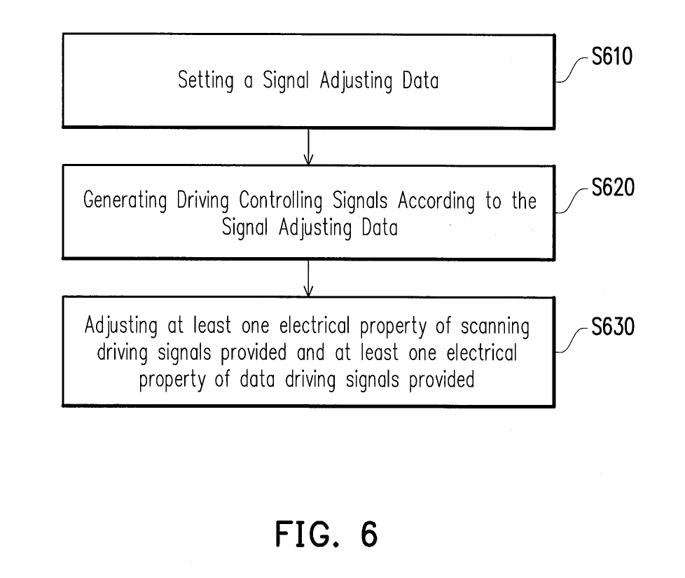

Referring to FIG. 6, FIG. 6 is a flowchart of a method for driving a display panel according to an embodiment of the invention. As summarized in the above embodiments, a method for driving a display panel of the invention includes the following. First, signal adjusting data is set (Step S610). Multiple driving controlling signals are also generated according to the signal adjusting data (Step S620). Next, at least one electrical property of multiple scanning driving signals provided and at least one electrical property of multiple data driving signals provided are adjusted according to the driving controlling signals (Step S630). The scanning driving signals are provided to the scanning lines and the data driving signals are provided to the data lines respectively, wherein the signal adjusting data is generated according to the impedance values of the multiple scanning lines and the multiple data lines. The method for driving the display panel of the invention is illustrated in detail in the above embodiments. Redundant descriptions are not provided below.

In summary, the display driving apparatus and the method for driving display panel provided by the embodiments of the invention at least have the following advantages. The invention sets the signal adjusting data according to the impedance values of the scanning lines as well as the data lines and generates the driving controlling signals according to the signal adjusting data. Driving voltage, driving enabling time, driving current and driving double reference voltage of the scanning driving signals provided are adjusted according to the driving controlling signals. Further, gamma driving voltage of the data driving signals is adjusted according to the driving controlling signals. Afterward, the scanning driving signals are provided to the scanning lines and the data driving signals are provided to the data lines.

Accordingly, when the user carries out surface layout of the display panel in accordance with design requirements, poor display quality, i.e. band mura and horizontal stripe image in the display panel, which results from a great variation of the product of resistance and capacitance due to different impedances generated by the scanning lines and the data lines, is improved. That is, display quality of the display is significantly improved by reducing resistor-capacitor effects (RC effect).

Though the above embodiments have disclosed the invention, they are not intended to limit the invention. Modifications and alterations may be made by one of ordinary skill in the art without departing from the spirit and scope of the invention. Therefore, the protection scope of the invention falls in the appended claims.

What is claimed is:

1. A display driving apparatus, comprising:
a display panel comprising a plurality of scanning lines and a plurality of data lines;
a controller receiving a signal adjusting data and generating a plurality of driving controlling signals according to the signal adjusting data; and
a driving circuit coupled to the controller, the scanning lines, and the data lines, the driving circuit adjusting at least an electrical property of a plurality of scanning driving signals provided and at least an electrical property of a plurality of data driving signals provided according to the driving controlling signals, the scanning driving signals being provided to the scanning lines while the data driving signals being provided to the data lines,
wherein the signal adjusting data is generated according to impedance values of the scanning lines and the data lines.

2. The display driving apparatus according to claim 1, wherein the driving circuit comprises:
a gate driving circuit coupled to the controller and the scanning lines and generating the scanning driving signals according to the driving controlling signals; and
a source driving circuit coupled to the controller and the data lines and generating the data driving signals according to the driving controlling signals.

3. The display driving apparatus according to claim 1, wherein the at least one electrical property of the scanning driving signals comprises at least one of a driving voltage, a driving enabling time and a driving current.

4. The display driving apparatus according to claim 1, wherein each of the scanning driving signals, which is generated by the driving circuit according to the controller via the driving controlling signals, comprises a first scanning sub-period and a second scanning sub-period in a scanning enabling period, wherein each of the scanning driving signals is made equal to a first scanning driving voltage in the first scanning sub-period, and each of the scanning driving signals is transited to a second scanning driving voltage in the second scanning sub-period, wherein the first scanning driving voltage and the second scanning driving voltage are unequal.

5. The display driving apparatus according to claim 1, wherein the at least one electrical property of the data driving signals comprises at least one of a gamma driving voltage and a driving enabling time.

6. The display driving apparatus according to claim 1, wherein the signal adjusting data comprises N adjusting values of the scanning driving signals, and the controller groups the scanning lines into N scanning areas and adjusts at least one electrical property of the scanning driving signal corresponding to at least one scanning line in each of the scanning areas according to the adjusting value of the scanning driving signal corresponding to each of the scanning areas, wherein N is a positive integer.

7. The display driving apparatus according to claim 1, wherein the signal adjusting data comprises M adjusting values of the data driving signals, and the controller groups the data lines into M data areas and adjusts at least one electrical property of the data driving signal corresponding to at least one data line in each of the data areas according to the adjusting value of the data driving signal corresponding to each of the data areas, wherein M is a positive integer.

8. The display driving apparatus according to claim 1, further comprising:
a memory unit coupled to the controller for storing the signal adjusting data and providing the signal adjusting data to the controller.

9. A method for driving a display panel, which comprises a plurality of scanning lines and a plurality of data lines, the driving method comprising:
setting a signal adjusting data;
generating a plurality of driving controlling signals according to the signal adjusting data; and
adjusting at least an electrical property of a plurality of scanning driving signals and at least an electrical property of a plurality of data driving signals according to the driving controlling signals, and the scanning driving signals and the data driving signals being respectively provided to the scanning lines and the data lines,
wherein the signal adjusting data is generated according to impedance values of the scanning lines and the data lines.

10. The driving method according to claim 9, wherein the at least one electrical property of the scanning driving signals comprises at least one of a driving voltage, a driving enabling time and a driving current.

11. The driving method according to claim 9, wherein each of the scanning driving signals comprises a first scanning sub-period and a second scanning sub-period in a scanning enabling period, wherein each of the scanning driving signals is made equal to a first scanning driving voltage in the first scanning sub-period, and each of the scanning driving signals is transited to a second scanning driving voltage in the second scanning sub-period, wherein the first scanning driving voltage and the second scanning driving voltage are unequal.

12. The driving method according to claim 9, wherein the at least one electrical property of the data driving signals comprises a gamma driving voltage.

13. The driving method according to claim 9, wherein the signal adjusting data comprises N adjusting values of the scanning driving signals, and the controller groups the scanning lines into N scanning line clusters and adjusts at least one electrical property of the scanning driving signal corresponding to at least one scanning line of each of the scanning line clusters according to the adjusting value of the scanning driving signal corresponding to each of the scanning line clusters, wherein N is a positive integer.

14. The driving method according to claim 9, wherein the signal adjusting data comprises M adjusting values of the data driving signals, and the controller groups the data lines into M data line clusters and adjusts at least one electrical property of the data driving signal corresponding to at least one data line of each of the data line clusters according to the adjusting value of the data driving signal corresponding to each of the data line clusters, wherein M is a positive integer.
